(19) United States
(12) Patent Application Publication
(10) Pub. No.: US 2013/0136397 A1
(43) Pub. Date: May 30, 2013

(54) TABLET COMPUTER

(71) Applicant: I-THUN LIN, Tu-Cheng (TW)

(72) Inventor: I-THUN LIN, Tu-Cheng (TW)

(73) Assignee: HON HAI PRECISION INDUSTRY CO., LTD., Tu-Cheng (TW)

(21) Appl. No.: 13/450,472

(22) Filed: Apr. 19, 2012

(30) Foreign Application Priority Data
Nov. 25, 2011 (TW) 100143416

(51) Int. Cl. G02B 6/26; G02B 6/36

(52) U.S. Cl. 385/50; 385/88

(57) ABSTRACT

A tablet computer includes a main body and an optical port module mounted on a sidewall of the main body. The optical port module includes a mounting portion and at least one first optical fiber mounted on the mounting portion. The mounting portion forms a mounting surface and defines at least one first receiving hole. The at least one first optical fiber is received in corresponding first receiving hole. An end of the at least one first optical fiber protrudes from the mounting surface, for transmitting optical signals.

### BACKGROUND

1. Technical Field

The present disclosure relates generally to tablet computers, especially to a tablet computer having an optical port module.

2. Description of Related Art

A varieties of miniaturized electronic devices are very popular, such as notebooks, tablet computers, cameras, mobile phones, for example. Sometimes those devices may need to connect with other electronic devices for transmitting data via a Universal Serial Bus (USB) or infrared transmission. However, the normal USB port connects two devices by using a male connector and a female connector nested with the male connector, for abutting copper wires of the male connector with copper wires of the female connector, a major thickness of about 1.8 mm to 4 mm is desired for the function. It has become a disadvantage for the miniaturization of the electronic devices. In addition, the copper wire transmits electrical signals, and the electrical signals are transmitted in a low speed, and are easily interfered with by electromagnetism, thus resulting in a low transmitting precision. The infrared transmission sometimes is not adopted because of it is unsecure.

Therefore, there is room for improvement within the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of one embodiment of a tablet computer.

FIG. 2 is an enlarged, isometric view of a circled portion II shown in FIG. 1.

FIG. 3 is an isometric view of a photoelectric converter corresponding to the tablet computer shown in FIG. 1, the photoelectric converter including an optical port module.

FIG. 4 is an enlarged, isometric view of the optical port module shown in FIG. 3.

### DETAILED DESCRIPTION

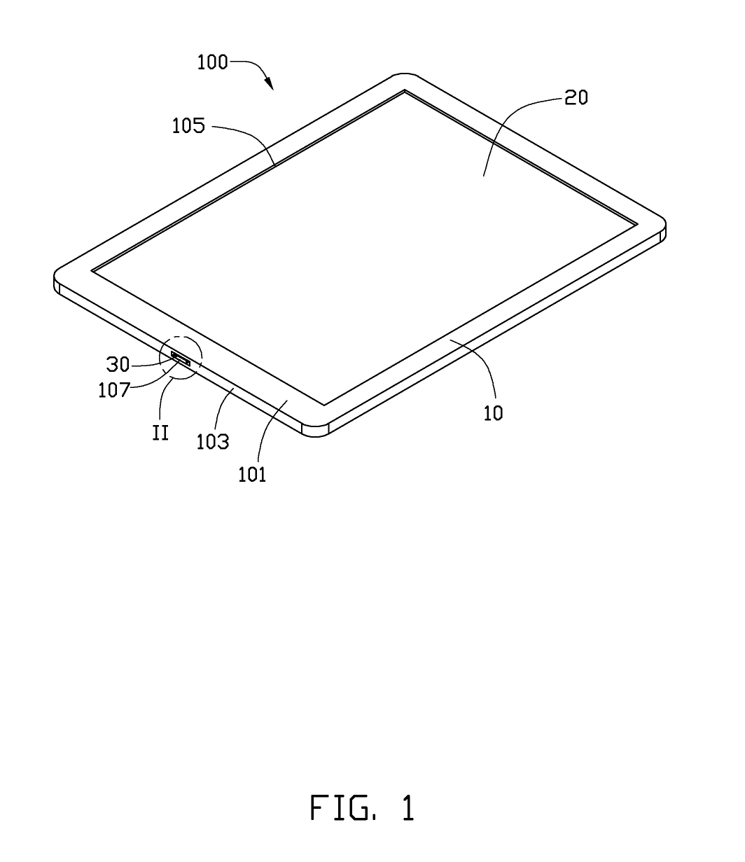

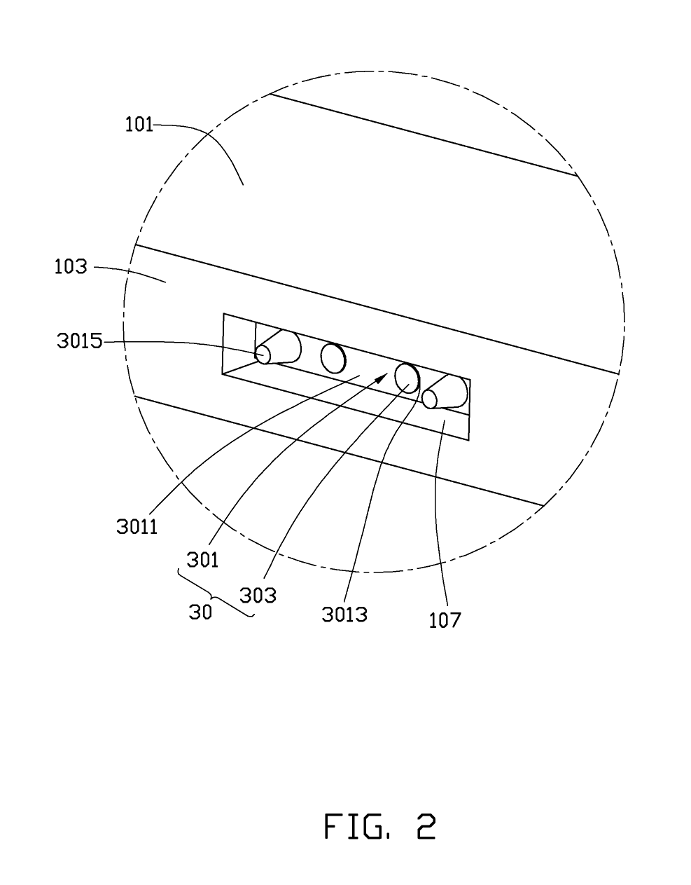

FIGS. 1 and 2, is one embodiment of a tablet computer 100 including a main body 10, a display 20 mounted in the main body 10 and an optical port module 30 inserted into a sidewall of the main body 10. The electronic device 100 further includes various function modules (not shown in FIGS. 1 to 4), such as circuit boards, and display modules, for example, received between the main body 10 and the display 20, to perform corresponding functions and features. However for simplicity, in the following embodiment, only the main body 10, the display 20, and the optical port module 30 are described.

The main body 10 is substantially a rectangular frame, and forms an end surface 101 parallel to the display 20 and a sidewall 103 perpendicular to the end surface 101. The main body 10 defines a substantially rectangular opening 105 at the end surface 101 for exposing the display 20, and defines a bar-type receiving groove 107 at the sidewall 103 for receiving the optical port module 30. The display 20 is substantially rectangular, and is fixed in the main body 10 beside the opening 105.

The optical port module 30 transmits optical signals when connected with corresponding optical plug module of other electronic device. The optical port module 30 includes a mounting portion 301 and at least one first optical fiber 303. In the illustrated embodiment, there are two first optical fibers 303.

The mounting portion 301 is substantially a bar, and is received in the receiving groove 107. The mounting portion 301 connects with an inner face of the main body 10 in the receiving groove 107. The mounting portion 301 forms a mounting surface 3011 exposed from the receiving groove 107. At least one positioning post 3015 protrude out from the mounting surface 3011. The positioning post 3015 positions the optical plug module of other electronic device when connecting with the optical port module 30. The mounting portion 301 defines at least one first mounting hole 3013 corresponding to the first optical fibers 303 at the mounting surface 3011, for mounting the first optical fibers 303. In the illustrated embodiment, there are two corresponding mounting holes 3013. There are two substantially conical frustum positioning posts 3015 respectively positioned at two opposite sides of the mounting holes 3013, and aligning with the mounting holes 3013 in a straight line. The positioning posts 3015 can be other shapes depending on alternative embodiments, for positioning, such as cylindrical posts, for example.

The first optical fibers 303 are inserted into corresponding mounting holes 3013, and a distal end protrudes out from the mounting surface 3011, for connecting with the optical plug of fiber plug module.

The receiving groove 107 can be other shapes that match the shapes of the mounting portion 301 to receive the mounting portion 301, such as circular, triangular, for example. The number of the first optical module 303 can be three, or four, for example.

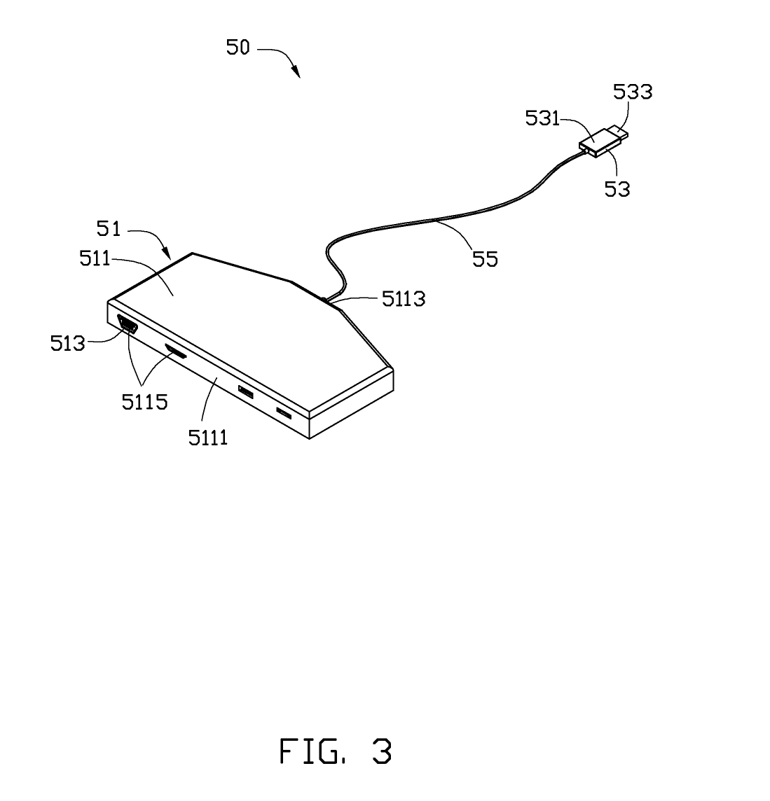

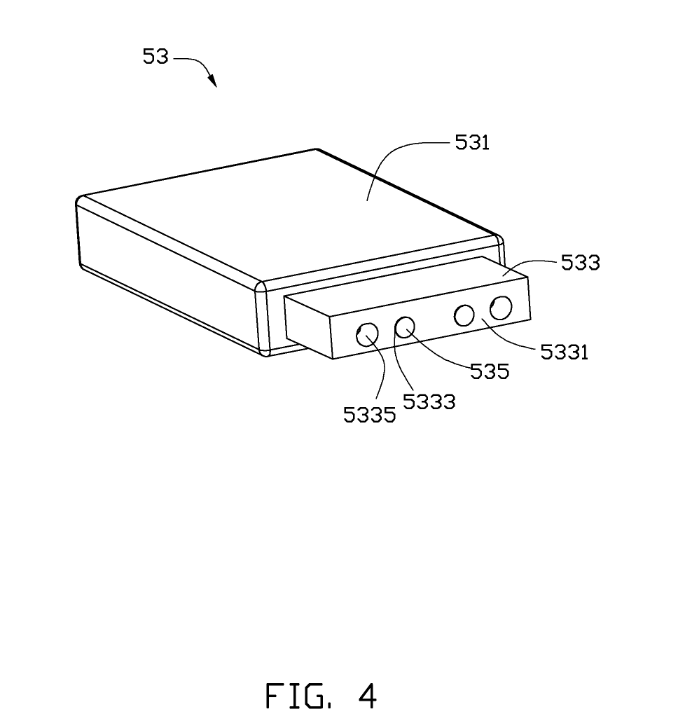

Referring to FIGS. 3 and 4, the tablet computer 100 further includes a photoelectric converter 50 engaging with the optical port module 30, allowing the tablet computer 100 to connect with other electronic devices with different ports, such as an electronic device having a plurality of USB ports.

The photoelectric converter 50 includes a converting portion 51, an optical plug module 53, and a transmitting wire 55 connecting the converting portion 51 and the optical plug module 53. The converting portion 51 is used for converting electrical signals received from other electronic devices to optical signals or converting optical signals received from the transmitting wire 55 to electrical signals. The optical plug module 53 engages with the optical port module 30 to transmitting optical signals. The transmitting wire 55 transmits optical signals between the converting portion 51 and the optical plug module 53.

The converting portion 51 is a substantially polygonal cube, and includes a base body 511 and a plurality of ports 513 of different types mounted on the base body 511. The base body 511 forms an inserting sidewall 5111 and a fixing sidewall 5113 opposite to the inserting sidewall 5111. The base body 511 defines a plurality of inserting holes 5115 with different shapes in the inserting sidewall 5111, for receiving the ports 513 with different types. The types of the ports 513 can be designed for achieving different functions, such as USB ports, Video Graphics Array (VGA) ports, display ports, High Definition Multimedia Interface (HDMI) ports, for example. In the illustrated embodiment, there are four inserting holes 5115 and corresponding ports 513. The four ports 513 include an USB port, a VGA port, a Display Port, and a HDMI port.

The optical plug module 53 includes a clamping body 531, a plug portion 533 protruding outwards from the clamping body 531, and at least one second optical fiber 535 mounted on the plug portion 533. The clamping body 531 clamps the plug portion plug portion 533 to avoid disengagement from the optical port module 30. In the illustrated embodiment, the clamping body 531 is substantially rectangular, for being clamped conveniently. The clamping body 531 can be other shapes, such as globoid. There are two second optical fibers 535.

The plug portion 533 is substantially a bar corresponding to the mounting portion 301, and is inserted in the receiving groove 107 and connected with the mounting portion 301 to transmit optical signals. The plug portion 533 forms a connecting surface 5331 opposite to the clamping body 531, and has at least one second mounting hole 5333 and at least one positioning hole 5335 defined in the connecting surface 5331. In the illustrated embodiment, there are two second mounting holes 5333 corresponding to the second optical fibers 535, for receiving the second optical fibers 535. There are two conical-frustum shaped positioning holes 5335 corresponding to the positioning posts 3015, for receiving and positioning the positioning posts 3015. The positioning holes 5335 are respectively located beside the second mounting holes 5333, and are aligned with the second mounting holes 5333 in a straight line.

Each second optical fiber 535 is inserted into the corresponding second mounting hole 5333, and has an end thereof protruding from the connecting surface 5331, for connecting with the corresponding first optical fiber 303 to transmit optical signals. The opposite ends of the transmitting wire 55 are respectively fixed on the fixing sidewall 5113 and a sidewall of the clamping body 531 opposite to the plug portion 533.

In use, the plug portion 533 is inserted into the receiving groove 107 and connects with the optical port module 30, the first optical fibers 303 connects with the second optical fibers 535 and the positioning posts 3015 are inserted into the positioning holes 5335. The ports 513 are connected with an electronic device (not shown). In the illustrated embodiment, one of the ports 513 connects with a mobile phone. Thus, the tablet computer 100 is connected with the mobile phone via the photoelectric converter 50. The optical signals of the tablet computer 100 are transmitted to the converting portion 51 via the first optical fibers 303, the second optical fibers 535, and the transmitting wire 55, then are converted to electrical signals by the converting portion 51, and the electrical signal are transmitted to the mobile phone. In reverse, the electrical signals of the mobile phone are transmitted to the converting portion 51, and are converted to optical signals by the converting portion 51, and then the optical signals are transmitted to the tablet computer 100 via the transmitting wire 55, the second optical fibers 535, and the first optical fibers 303. Thus, the tablet computer 100 exchanges signals with the mobile phone via the photoelectric converter 50.

The optical plug module 53 can be disposed on an electronic device directly, for example, mounted on a memory storage card.

Because the first optical fibers 303 abuttingly joins with the second optical fibers 535, the optical port module 30 uses a space a little larger than the size of the first optical fibers 303, thus saving space in the tablet computer 100. In addition, the tablet computer 100 may exchange data with other electronic devices that have a variety of ports by transmitting optical signals via the photoelectric converter 50, thus the optical signals are transmitted speedily and without interference.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A tablet personal computer comprising:
a main body; and
an optical port module mounted on a sidewall of the main body, the optical port module comprising a mounting portion and at least one first optical fiber mounted on the mounting portion;
wherein the mounting portion forms a mounting surface, and defines at least one first receiving hole; the at least one first optical fiber is received in corresponding first receiving hole; an end of the at least one first optical fiber protrudes out from the mounting surface, for transmitting optical signals.

2. The tablet personal computer of claim 1, wherein the sidewall of the main body defines a receiving groove, the optical port module is received in the receiving groove and is fixed with the main body.

3. The tablet personal computer of claim 1, wherein the mounting portion forms at least one positioning post protruding from the mounting surface, and the at least one positioning post aligns with the at least one first receiving hole.

4. The tablet personal computer of claim 3, wherein the at least one positioning post is conical frustum post; and the at least one receiving hole is conical frustum shaped hole corresponding to the at least one positioning post.

5. The tablet personal computer of claim 1 further comprises a photoelectric converter, wherein the photoelectric converter comprises a converting portion, a optical plug module and a transmitting wire connecting the converting portion with the optical plug module; the converting portion is capable of converting the optical signals to electrical signals or converting the electrical signals to optical signals; the transmitting wire is capable of transmitting optical signals; the optical plug module comprises a plug portion and at least one second optical fiber mounted on the plug portion; the plug portion forms a connecting surface at a sidewall, and the plug portion defines at least one second receiving hole at the connecting surface; the at least one second optical fiber is received in corresponding second receiving hole; and an end of the second optical fiber protrudes from the connecting surface for jointing with the at least one first optical fiber to transmit optical signals.

6. The tablet personal computer of claim 5, wherein the photoelectric converter further comprises a clamping body; the plug portion is mounted on the clamping body at a sidewall; and an end of the transmitting wire connects with the clamping body at a sidewall opposite to the plug portion.

7. The tablet personal computer of claim 5, wherein the plug portion defines at least one positioning hole at the connecting surface, for engaging with the at least one positioning post.

8. The tablet personal computer of claim 7, wherein the at least one positioning hole aligns with the at least one second receiving hole.

9. A tablet personal computer comprising:
a main body;
an optical port module mounted on a sidewall of the main body, the optical port module comprising a mounting portion and at least one first optical fiber mounted on the mounting portion; and
a photoelectric converter comprising a converting portion, a optical plug module and a transmitting wire connecting the converting portion with the optical plug module;
wherein the converting portion is capable of converting optical signals to electrical signals or converting the electrical signals to the optical signals; the transmitting wire is capable of transmitting the optical signals; the optical plug module comprises a plug portion and at least one second optical fiber mounted on the plug portion; the at least one second optical fiber is capable of jointing with the at least one first optical fiber to transmit the optical signals.

10. The tablet personal computer of claim 9, wherein the mounting portion forms a mounting surface, and defines at least one first receiving hole; the at least one first optical fiber is received on corresponding first receiving hole; and an end of the at least one first optical fiber protrudes from the mounting surface for transmitting the optical signals.

11. The tablet personal computer of claim 10, wherein the sidewall of the main body defines a receiving groove, the optical port module is received in the receiving groove and is fixed with the main body.

12. The tablet personal computer of claim 10, wherein the mounting portion forms at least one positioning post protruding from the mounting surface, and the at least one positioning post aligns with the at least one first receiving hole.

13. The tablet personal computer of claim 12, wherein the at least one positioning post is conical frustum post; and the at least one receiving hole is conical frustum shaped hole corresponding to the at least one positioning post.

14. The tablet personal computer of claim 9, wherein the plug portion forms a connecting surface at a sidewall thereof, and the plug portion defines at least one second receiving hole at the connecting surface; the at least one second optical fiber is received in corresponding second receiving hole; and an end of the second optical fiber protrudes from the connecting surface.

15. The tablet personal computer of claim 9, wherein the photoelectric converter further comprises a clamping body; the plug portion is mounted on a sidewall of the clamping body; and an end of the transmitting wire connects with the a sidewall of clamping body opposite to the plug portion.

16. The tablet personal computer of claim 15, wherein the plug portion defines at least one positioning hole at the connecting surface, for engaging with the at least one positioning post.
